(19) United States
(12) Patent Application Publication
(10) Pub. No.: US 2010/0113666 A1
(43) Pub. Date: May 6, 2010

(54) DIBLOCK COPOLYMER INCLUDING UNITS DERIVED FROM STYRENE AND UNITS DERIVED FROM ACRYLIC ACID

(75) Inventor: Wojciech Bzducha, Courbevoie (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Rhodia Services, Aubervilliers Cedex (FR)

(21) Appl. No.: 12/523,693

(22) PCT Filed: Jan. 16, 2008
(86) PCT No.: PCT/EP2008/050429

§ 371 Date: Dec. 14, 2009

(30) Foreign Application Priority Data
Jan. 19, 2007 (FR) 07 00368

(51) Int. Cl. C08F 293/00; C08K 5/05; C08F 8/12; C08F 12/08; C08F 20/06

(52) U.S. Cl. 524/379; 524/522; 525/221; 525/227

(57) ABSTRACT

The invention relates to a new diblock copolymer including units derived from styrene and units derived from acrylic acid. It comprises a block containing the units derived from styrene, and a block containing the units derived from acrylic acid and units derived from an alkyl acrylate. The invention also relates to a method for preparing the copolymer.

A subject matter of the present invention is a novel diblock copolymer comprising units deriving from styrene and units deriving from acrylic acid. It comprises a block comprising units deriving from styrene and a block comprising units deriving from acrylic acid and units deriving from an alkyl acrylate. The invention also relates to a process for the preparation of the copolymer.

Numerous copolymers comprising amphiphilic blocks have been described in the literature, in particular since the discovery of controlled radical polymerization processes which facilitate access to such products. Uses of some copolymers comprising amphiphilic blocks in water-based formulations, as emulsifiers or coemulsifiers or as dispersants or also as gelling agents, have also been described. Uses of some block copolymers in detergent compositions, in plant protection compositions, in coating compositions, in surface-modifying compositions or in cosmetic compositions, in particular in shampoos, have in particular been described.

However, there still exists a need for novel formulations, the functions and properties of which are varied, for example by introducing a novel property or by improving a property. It is possible to seek to combine different known starting materials in order to bring about these properties. It is also possible to bring about these properties using novel starting materials, acting alone or in combination with others. There thus exists a need for novel starting materials which can introduce or modify the properties of a formulation.

The present invention meets this need by providing a (block A)-(block B) diblock copolymer in which:
the block A comprises at least 90% by weight (with respect to the block A) of units deriving from styrene,
the block B is a random block comprising (with respect to the block B):
   (a) from 34 to 95% by weight, preferably from 64 to 75% by weight, of units deriving from acrylic acid in the acid or salified form, and
   (b) from 5 to 66% by weight, preferably from 25 to 36% by weight, of units deriving from a C₁-C₄ alkyl acrylate,
the proportion by weight of the block 3 with respect to the copolymer is greater than or equal to 50%,
its theoretical average molecular weight is greater than or equal to 20 000 g/mol and preferably between 20 000 and 50 000 g/mol.

The invention also relates to a process for the preparation of the copolymer.

The copolymer of the invention exhibits in particular very high moisturizing properties. It may thus have applications in the cosmetics industry.

### DEFINITIONS

In the present patent application, the term “diblock copolymer” relates to an architecture formed of a block copolymer composed of two blocks and not substantially exhibiting another sequence of blocks.

In the present patent application, “unit deriving from a monomer” denotes a unit which can be obtained directly from said monomer by polymerization. Thus, for example, a unit deriving from an acrylic or methacrylic acid ester does not cover a unit of formula —CH₂—CH(COOH)— or —CH₂—C(CH₃)(COOH)—, for example obtained by polymerizing an acrylic or methacrylic acid ester and then by hydrolyzing. Thus, the terminology “unit deriving from a monomer” relates only to the final composition of the polymer and is independent of the polymerization process used to synthesize the polymer.

In the present patent application, the ratio by weight between the blocks corresponds to the ratio between the weights of the monomers (or mixtures of monomers) used for the preparation of the blocks (taking into account the variations in weight related to a subsequent hydrolysis). The proportions by weight of the blocks are the proportions with respect to the complete diblock copolymer and correspond to the proportions by weight of the monomers (or mixtures of monomers) used for the preparation of the blocks, with respect to all of the monomers used to prepare the diblock copolymer (taking into account the variations in weights related to a subsequent hydrolysis).

In the present patent application, the weights and ratios related to the blocks are indicated as acid equivalents (units deriving from acrylic acid in the acid form, in contrast to a salified form of sodium acrylate type).

In the present patent application, hydrophilic monomer is understood to mean a monomer which has affinity for water and which typically is not capable of forming a two-phase macroscopic solution in distilled water at 25° C. at a concentration of 1% by weight.

In the present patent application, the molar mass M_{A} of a mixture of monomers A₁ and A₂ with respective molar masses of M_{A1} and M_{A2} present in respective numbers of n_{A1} and n_{A2} denotes the number-average molar mass M_{A}=M_{A1}n_{A1}/(n_{A1}+n_{A2})+M_{A2}n_{A2}/(n_{A1}+n_{A2}). The molar mass of a mixture of units in a macromolecular chain or a macromolecular chain portion (for example a block) is defined in the same way, with the molar masses of each of the units and the number of each of the units.

In the present patent application, the measured average molecular weight of a first block or of a copolymer denotes the number-average molecular weight in polystyrene equivalents of a block or of a copolymer, IC measured by steric exclusion chromatography (SEC), in THF, with calibration using polystyrene standards. The measured average molecular weight of the same block in a copolymer comprising n blocks is defined as the difference between the measured average molecular weight of the copolymer and the measured average molecular weight of the copolymer comprising (n−1) blocks from which it is prepared.

For the sake of simplicity, it is common to express the average molecular weights of the blocks as “theoretical” or “targeted” average molecular weights, taking into consideration a complete and perfectly controlled polymerization. In this case, one macromolecular chain is formed per transfer functional group of a transfer agent; in order to obtain the molecular weight, it is sufficient to multiply the average molar mass of the units of a block by the number of units per block (amount by number of monomer by amount by number of transfer agent). The differences caused by small amounts of comonomers, such as methacrylic acid, can be ignored in these calculations. The theoretical or targeted average molecular weights of the block B are expressed taking into consideration a complete hydrolysis (the weights are expressed with the fiction of a degree of hydrolysis of 1). The theoretical average molecular weight M_{block} of a block is typically calculated according to the following formula:

$${M}_{block} = {\sum }_{i} {M}_{i}^{*} \frac{{n}_{i}}{{n}_{precursor}} ,$$

where Mᵢ is the molar mass of a monomer i, nᵢ is the number of moles of the monomer i and n_{precursor} is the number of moles of functional groups to which the macromolecular chain of the block will be bonded. The functional groups can originate from a transfer agent (or a transfer group) or an initiator, a preceding block, and the like. If a preceding block is concerned, the number of moles can be regarded as the number of moles of a compound to which the macromolecular chain of said preceding block has been bonded, for example a transfer agent (or a transfer group) or an initiator. In practice, the theoretical average molecular weights are calculated from the number of moles of monomers introduced and from the number of moles of precursor introduced.

The “theoretical” or “targeted” average molecular weight of a block copolymer is considered to be the addition of the average molecular weights of each of the blocks, taking into consideration a complete hydrolysis (the weights are expressed with the fiction of a degree of hydrolysis of 1), if such a hydrolysis has been carried out.

In the present patent application, the targeted or theoretical total weight of a block is defined as the weight of the macromolecular chain, taking into consideration a complete and perfectly controlled polymerization. In order to obtain the total weight, it is sufficient to multiply the molar mass of a unit of a block by the number per block of this unit and to add the weights thus obtained for each type of unit in the block. The differences caused by small amounts of comonomers, such as methacrylic acid, can be ignored in these calculations. The theoretical or targeted total weights of the block B are expressed taking into consideration the effect of a partial hydrolysis the fiction of a degree of hydrolysis of 1 is not used for this descriptor), if such a hydrolysis has been carried out.

In the present patent application, the degree of hydrolysis T is defined as the ratio of the number of units deriving from acrylic acid or an acrylic acid salt to the number of units deriving from the C₁-C₄ alkyl acrylate which are present in a copolymer before hydrolysis. The number of units deriving from the C₁-C₄ alkyl acrylate is regarded as being equal to the amount by number of alkyl acrylate monomer used for the preparation of the copolymer before hydrolysis. The number of units deriving from acrylic acid or from an acrylic acid salt can be determined by any known method, in particular by potentiometric acid/base titration of the number of —COONa groups using a strong acid, for example using hydrochloric acid.

In the present patent application, transfer agent is understood to mean an agent capable of bringing about controlled radical polymerization in the presence of unsaturated monomers and optionally of a source of free radicals.

### Copolymer

The diblock copolymer is a linear copolymer. The block B comprises two different units. They will generally be distributed randomly in the block B. The block B is then a random block.

The theoretical average molecular weight of the copolymer is greater than or equal to 20 000 g/mol. It can in particular be greater than or equal to 25 000 g/mol or even 28 000 g/mol. It can be less than 50 000 g/mol or even 40 000 g/mol. It is preferably between 20 000 g/mol and 50 000 g/mol and more preferably still between 25 000 g/mol and 50 000 g/mol or even between 28 000 g/mol and 40 000 g/mol.

It is mentioned that the block A can comprise up to 10% of units other than the units deriving from styrene. It is mentioned that the block B can comprise units other than the units deriving from acrylic acid and the units deriving from the alkyl acrylate. Such units are taken into account in the composition of the block B (proportion of the various units), the total of the units being 100%.

It is mentioned that the ratio by weight of the units deriving from acrylic acid to the units deriving from the C₁-C₄ alkyl acrylate is preferably between 34/66 and 95/5, preferably between 64/36 75/25.

The C₁-C₄ alkyl acrylate is preferably an alkyl acrylate which can be hydrolyzed to give acrylic acid. The units deriving from the C₁-C₄ alkyl acrylate are preferably derived from an alkyl acrylate which can be hydrolyzed to give acrylic acid. Thus, by a preferred process, the units deriving from acrylic acid can be generated, during a partial hydrolysis, from the units deriving from the alkyl acrylate.

Mention is made in particular, as C₁-C₄ alkyl acrylates, of ethyl acrylate, n-propyl acrylate, isopropyl acrylate, n-butyl acrylate or tert-butyl acrylate. Ethyl acrylate and tert-butyl acrylate are in particular known as being able to be easy to hydrolyze.

The C₁-C₄ alkyl acrylate of the copolymer of the invention is advantageously ethyl acrylate (often denoted EA or EtA).

The block A and/or the block B can comprise (with respect to the weight of the block A and/or the block B comprising the hydrophilic monomer) up to 10% by weight (in particular from 0.1% to 9.99% by weight), preferably up to 5% by weight (in particular from 0.1% to 4.99% by weight, for example approximately 2% or from 0.1% to 1.8% by weight), of an additional ionic or nonionic hydrophilic comonomer.

Mention may be made, among additional ionic or nonionic hydrophilic comonomers, for example, of acrylamide, hydroxyethyl(meth)acrylate or methacrylic acid (MAA) in the acid or salified form. Preference is more particularly given to the use of methacrylic acid or one of its salts. The block A can also comprise, as additional hydrophilic monomer, acrylic acid in the acid or salified form.

Preferably, the copolymer does not comprise a boronic functional group in the acid or salified form.

The proportion by weight of the block B with respect to the copolymer can be greater than or equal to 75%, preferably greater than or equal to 85%, preferably greater than or equal to 87%, preferably greater than or equal to 94% and preferably between 94 and 97%.

The copolymer of the invention can in particular be presented in one of the following ways:
in a solid or dry form, or
in the form of a fluid concentrated ingredient comprising a carrier, in a concentration preferably of greater than 10% by weight.

If it is in the form of a fluid concentrated ingredient comprising a carrier, in a concentration preferably of greater than 10% by weight, the carrier can in particular comprise water and/or an alcohol solvent, the alcohol preferably being chosen from ethanol or isopropanol. The alcohol can in particular contribute to fluidifying the copolymer and to rendering it easier to use industrially. The carrier can be water or a mixture of more than 50% by weight of water and of less than 50% by weight of alcohol. The copolymer concentration can be at least 25% by weight and preferably at most 75% by weight.

If the copolymer is in the solid or dry form, it can in particular be in the form of a powder, granules or extrudate. The copolymer in the solid form can typically exhibit a content of liquid compounds, for example water, of less than 10% by weight, preferably of less than 5% by weight, preferably less than 1% by weight. It is not out of the question for the copolymer in the solid form to comprise small amounts of liquid compounds, for example of water, such as contents of greater than 0.05% by weight, for example from 0.1 to 1% by weight. The solid forms can be obtained by removing a liquid carrier, in particular a liquid medium, preferably an aqueous medium, in which the copolymer is prepared. It is possible, for example, to carry out a drying.

### Process

The copolymer of the invention can be prepared by any appropriate process comprising a polymerization phase. The copolymer according to the invention can be obtained by any known method, whether by controlled or uncontrolled radical polymerization, by ring opening polymerization (in particular anionic or cationic), by anionic or cationic polymerization, or by chemical modification of a polymer.

An advantageous process comprises the following stages:

stage I): the following is prepared:
a (block A)-(block B′) diblock copolymer, or
a triblock or star copolymer of (core)−[(block A)-(block B′)]ₓ or (core)-[(block B′)-(block A)]ₓ architecture where x is a mean number of greater than or equal to 2,

where
the block A comprises the units deriving from styrene, and
the block B′ comprises the units deriving from a C₁-C₄ alkyl acrylate,
   stage I′) optionally, for a triblock or star copolymer, the (core)-(block B′) or (core)-(block A) bonds are split, so as to obtain a (block A)-(block B′) diblock copolymer,
   stage II) the block B′ is hydrolyzed to give a block B in order to obtain the (block A)-(block B) diblock copolymer, the hydrolysis bringing about, if appropriate, for a triblock or star copolymer, splitting of the (core)-(block B′) or (core)-(block A) bonds, so as to obtain a (block A)-(block B) diblock copolymer,
   stage III), optional: deactivation of the transfer groups carried by macromolecular chains and/or purification of the (block A)-(block B) diblock copolymer and/or destruction of hydrolysis and/or deactivation byproducts.

The process can in addition optionally comprise a stage III), during and/or after stage II), of deactivation of transfer groups carried by macromolecular chains and/or of purification of the (block A)-(block B) diblock copolymer and/or of destruction of hydrolysis and/or deactivation byproducts.

The polymerization process as described above, applied to the preparation of copolymers resembling those of the invention, is described in particular in the document WO 01/16187.

It is mentioned that the terminologies of the (block A)-(block B′) type do not rule out, however, the presence of chemical groups of use (transfer groups or residues) in the polymerization, in particular at chain ends or at the center of chains. Thus, the diblock copolymer can in reality exhibit a formula of the R-(block A)-(block B′)-X type where X is a transfer group (for example, X is a transfer group of formula —S—CS—Z or a residue of such a group).

Stage I) is a polymerization stage. Stage I′) is optional and can optionally be applied if the copolymer prepared in stage I) is a triblock or star copolymer. However, if the copolymer prepared in stage I) is a triblock or star copolymer, it is possible to split the bond during a hydrolysis stage. If the splitting can be carried out during the hydrolysis stage, then stage I′) will not be very useful and it will preferably be dispensed with.

According to an advantageous form, stage I) is carried cut by emulsion polymerization in water.

The procedure can in particular be carried out as follows:
during stage I, the (block A)-(block B′) diblock copolymer is prepared by a process comprising the following intermediate stages Ia) and Ib):
   Ia) a first block A is prepared by bringing together:
      n_{T} mol of a transfer agent comprising a single transfer group,
      n_{A} mol of styrene or a mixture of monomers comprising at least 90% by weight of styrene and where n_{A}/n_{T}>5 and preferably <5000;
      and optionally a tree radical initiator,
   Ib) a second block B′ is prepared in order to obtain a (block A)-(block B′) diblock copolymer by bringing together:
      the block A obtained in the preceding stage,
      n_{B} mol of a hydrolyzable C₁-C₄ alkyl acrylate or of a mixture of monomers comprising at least 90% by weight of the hydrolyzable C₁-C₄ alkyl acrylate so that n_{B}/n_{T}>5 and preferably <5000;
      and optionally a free radical initiator;
during stage II), subsequent to stage I), the block B′ is hydrolyzed to a degree T in moles of between 0.4 and 0.96 in order to obtain said (block A)-(block B) diblock copolymer, and
20 000≦n_{A}/n_{T}M_{A}+M_{AA}n_{B}/n_{T}
[TM_{AA}n_{B}+(1−T) M_{B}n_{B}]/[M_{A}n_{A}+TM_{AA}n_{B} (1−T)M_{B}n_{B}]≧50%
   where M_{A} is the molar mass of the styrene or of the mixture of monomers comprising the styrene employed in stage Ia) and M_{B} is the molar mass of the C₁-C₄ alkyl acrylate or of the mixture of monomers comprising the C₁-C₄ alkyl acrylate employed in stage Ib).

According to an advantageous form, stages Ia) and Ib) of stage I) are carried out by emulsion polymerization in water.

The degree of hydrolysis T can advantageously be between 0.7 and 0.6; preferably, T is equal to 0.75.

Transfer agents of use for the implementation of the process (during stage I)) are known to a person skilled in the art and include in particular compounds comprising an —S—CS— transfer group for the implementation of polymerization processes known under the terms of RAFT and/or MADIX. Such processes and agents are explained in detail later.

During stage I) described above, it is possible to carry out the preparation of a first block from monomers or a mixture of monomers, from initiators and/or from agents which promote the control of the polymerization (transfer agents comprising —S—CS— or nitroxide groups, and the like) and then the growth of a second block on the first block in order to obtain a diblock copolymer with different monomers from those used for the preparation of the preceding block, and optionally with addition of initiators and/or of agents which promote the control of the polymerization. These processes for the preparation of block copolymers are known to a person skilled in the art. It is mentioned that the copolymer can exhibit, at the chain end or at the center of the chains, a transfer group or a residue of a transfer group, for example a group comprising an —S—CS— group (for example resulting from a xanthate, from a dithioester, from a dithiocarbamate or from a trithiocarbonate) or a residue of such a group.

During stage II), the units deriving from the hydrolyzable monomers of the block B' are partially hydrolyzed to form a block B comprising units deriving from acrylic acid in the acid or salified form (hydrolyzed units) and units deriving from the alkyl acrylate monomer (nonhydrolyzed units). These two types of units are distributed randomly in the block B; the block B can thus be regarded as a block in the form of a random copolymer comprising units deriving from alkyl acrylate and units deriving from acrylic acid in the acid or salified form. Naturally, the block B can comprise other units, often in minimum amounts, if a mixture of monomers is used during the implementation of stage Ib).

The block A comprises units deriving from styrene. The block A can be obtained from a mixture of monomers comprising at least 90% by weight, preferably at least 95% by weight, of styrene (“St”) and a hydrophilic comonomer or several hydrophilic comonomers. The block A can thus be a random copolymer comprising at least 90% by weight (in particular from 90% to 99.9% by weight), preferably at least 95% by weight (in particular from 95% to 99.9% by weight), of units deriving from styrene and up to 10% by weight (in particular from 0.1% to 9.99 or 10% by weight), preferably up to 5% by weight (in particular from 0.1% to 4.99 or 5% by weight, for example approximately 2% or from 0.1 to 1.8% by weight), of other units deriving from hydrophilic comonomer(s).

The block B′ comprises unite deriving from a hydrolyzable C₁-C₄ alkyl acrylate. The block B′ can be obtained from a mixture of monomers comprising at least 90% by weight (in particular from 90% to 99.9% by weight), preferably at least 95% by weight (in particular from 95% to 99.9% by weight), of a C₁-C₄ alkyl acrylate and one or more hydrophilic comonomer(s). The block B′ can thus be a random copolymer comprising at least 90% by weight (in particular from 90% to 99.9% by weight), preferably at least 95% by weight (in particular from 95% to 99.9% by weight), of units deriving from the C₁-C₄ alkyl and up to 10% by weight (in particular from 0.1% to 9.99 or 10% by weight), preferably up to 5% by weight (in particular from 0.1% to 4.99 or 5% by weight, for example approximately 2% or from 0.1 to 1.8% by weight), of other units deriving from hydrophilic comonomer(s).

The block B obtained from the block B′ after hydrolysis comprises units deriving from the hydrolyzable C₁-C₄ alkyl acrylate, units deriving from acrylic acid in the acid or salified form and optionally units deriving from a hydrophilic comonomer employed during stage Ib) of growth of the block B′, for example units deriving from methacrylic acid. The acrylic acid is generally present in the block B in the form of a salt. This form generally results from the conditions for implementing the hydrolysis and from the reactants used. An alkali metal salt, such as a sodium salt or a potassium salt, is generally involved. Consequently, the block B generally comprises units deriving from acrylic acid in the form of sodium acrylate or potassium acrylate.

Mention is made, among the hydrophilic comonomer(s) which can be of use in the preparation of the block A and/or of the block B′, of hydrophilic comonomer(s) capable of stabilizing an emulsion of monomers and/or of stabilizing the polymer obtained by emulsion polymerization. Mention may in particular be made of ionic or nonionic hydrophilic comonomers, such as acrylamide, hydroxyethyl(meth)acrylate, methacrylic acid (MAA) and their salts. It is preferable to use methacrylic acid or its salts. Methacrylic acid is not sensitive to hydrolysis. However, it can be salified during the hydrolysis. Use may also be made, as hydrophilic comonomer, for the preparation of the block A, of acrylic acid in the acid or salified form.

According to a specific embodiment, the block A and/or the black B′ or B comprises (with respect to block A and/or B and/or B′ comprising said hydrophilic monomer) from 0.1 to 10% by weight, preferably from 0.1 to 5% by weight, for example approximately 2% or from 0.1 to 1.8% by weight, of hydrophilic comonomer, in particular methacrylic acid in the acid or salified form.

Thus, during stage Ia), it is possible to use a mixture of monomers comprising at least 90% by weight, preferably at least 95% by weight, of styrene and up to 10% by weight, preferably up to 5% by weight, for example approximately 2% or from 0.1 to 1.8% by weight, of methacrylic acid in the acid or salified form.

During stage Ib), it is possible to use a mixture of monomers comprising at least 90% by weight, preferably at least 95% by weight, of C₁-C₄ alkyl acrylate, such as ethyl acrylate, and up to 10% by weight, preferably up to 5% by weight, for example approximately 2% or from 0.1 to 1.8% by weight, of methacrylic acid in the acid or salified form.

A few characteristics of the process for the preparation of the copolymers of the invention are explained in detail below.

### Stage I)

Preferably, for the polymerization stage I), use is made of “living” or “controlled” radical polymerization methods and particularly preferably of controlled or living radical polymerization methods employing a transfer agent comprising a transfer group of formula —S—CS—, known in particular under the names of RAFT or MADIX.

Reference may in particular be made, as examples of “living” or “controlled” polymerization processes, to:
the processes of applications WO 98/58974, WO 00/75207 and WO 01/42312, which employ a radical polymerization controlled by control agents of xanthate type,
the radical polymerization process controlled by control agents of dithioester or trithiocarbonate type of application WO 98/01478,
the radical polymerization process controlled by control agents of dithiocarbamate type of application WO 99/31144,
the radical polymerization process controlled by control agents of dithiocarbazate type of application WO 02/26836,
the radical polymerization process controlled by control agents of dithiophosphoric ester type of application WO 02/10223,
the process of application WO 99/03894, which employs a polymerization in the presence of nitroxide precursors, or processes employing other nitroxides or nitroxide/alkoxyamine complexes,
the process of application WO 96/30421, which uses an atom transfer radical polymerization (ATRP),
the radical polymerization process controlled by control agents of iniferter type according to the teaching of Otu et al., Makromol. Chem. Rapid. Commun., 3, 127 (1982),
the radical polymerization process controlled by iodine degenerative transfer according to the teaching of Tatemoto et al., Jap. 50, 127, 991 (1975), Daikin Kogyo Co Ltd Japan, and Matyjaszewski et al., Macromolecules, 28, 2093 (1995),
the radical polymerization process controlled by tetraphenylethane derivatives disclosed by D. Braun et al. in Macromol. Symp., 111, 63 (1996), or also
the radical polymerization process controlled by organocobalt complexes described by Wayland et al, in J. Am. Chem. Soc 116, 7973 (1994),
the radical polymerization process controlled by diphenylethylene (WO 00/39169 or WO 00/37507).

The polymerizations can be carried out in emulsion in water (“latex” process). These processes can employ emulsifying agents, generally surfactants. Without wishing to be committed to any one theory, it is believed that the emulsion preparation processes result in the formation of nodules of blocks A, which can Influence the physicochemical properties of the copolymer.

The polymerizations can be carried out in the presence of free radical initiators known to a person skilled in the art. Use may be made, for example, of sodium persulfate. It is typically possible to employ amounts of initiators of 5 to 50% by number, with respect to the amount of transfer agent.

It is mentioned that it would not be departing from the scope of the invention to employ and to adapt other processes of preparation resulting in triblock or star copolymers, subsequently modified (during a stage I′) or during stage II)) so as to obtain diblock copolymers. In particular, it is possible to envisage employing transfer agents comprising several transfer groups (for example trithiocarbonates Z—S—CS—S—Z) which result in telechelic copolymers of R-[(block B′)-(block A)]ₓ type, such as triblock or star copolymers of (core)-[(block A)-(block B′)]ₓ type (for example (block A)-(block B′)-R-(block B′)-(block A), such as (block A)-(block B′)-(core)-(block B′)-(block A) tri-block copolymers), and then to split (sever, “cleave”) the telechelic copolymers in order to obtain (block A)-(block B′) diblock copolymers. The severing can occur during the hydrolysis, in which case (block A)-(block B) diblock copolymers are obtained directly. In such cases, a person skilled in the art will adjust the operating conditions in order to target average molecular weights equivalent to those indicated, for example by multiplying the amounts of monomers introduced by the number of transfer groups included in the transfer agent. It is specified that, during stage I), a triblock copolymer is not typically prepared by a succession of 3 polymerization phases or at least one of the blocks might not be separated from the others by splitting during hydrolysis. Thus, the copolymer prepared during stage I) is not typically obtained by a polymerization process comprising a stage or polymerization of styrene or a mixture of monomers based on styrene, then a stage of polymerization of ethyl acrylate or of a mixture of monomers based on ethyl acrylate and then a stage of polymerization of styrene or of a mixture of monomers based on styrene, the polymerizations being carried out using a monofunctional transfer agent carrying a group of formula —S—CS—.

### Stage II)

During stage II), the respective amounts of the various units in the block 3 are controlled by the degree of hydrolysis. The composition of the block A may remain unchanged during hydrolysis if the block A does not comprise hydrolyzable units. However, it is not out of the question for the block A to be slightly modified during the hydrolysis stage.

Preferably, the hydrolysis stage II) is carried out by addition of a strong base, such as sodium hydroxide or potassium hydroxide. Typically, a proportion by number of base, with respect to the amount of hydrolyzable monomer used during stage Ib), is added which corresponds approximately to the targeted degree of hydrolysis, with optionally an excess of a few %. For example, an amount of sodium hydroxide of 75% by number of the amount of hydrolyzable ethyl acrylate employed during stage Ib) is introduced. An operation of homogeneous hydrolysis is preferably carried out by gradually adding the sodium hydroxide to the copolymer.

The hydrolysis stage can result in particular in the deactivation and/or the severing of certain transfer groups or other groups attached to the macromolecular chains. Stage II) can thus generate byproducts which it is desirable to remove or generate groups on the macromolecular chains which it is desirable to chemically modify. Such operations can be carried out during a stage III).

### Stag III)

Stage III) is a stage of deactivation of transfer groups carried by macromolecular chains and/or of purification of the (block A)-(block B) diblock copolymer and/or of destruction of hydrolysis and/or deactivation byproducts.

During the optional stage III), the block copolymers obtained or the hydrolysis byproducts can be subjected to a reaction for purification from or destruction of certain entities, for example by processes of hydrolysis, oxidation, reduction, pyrolysis, ozonolysis or substitution type. A stage of oxidation with aqueous hydrogen peroxide solution is particularly appropriate for treating sulfur-comprising entities. It is mentioned that some of these reactions or operations can take place entirely or in part during stage II). In this case, for these reactions or operations, the two stages are simultaneous.

As indicated above, the average molecular weights of the (block A)-(block B′) diblock copolymer before hydrolysis or of each of the blocks typically depend on the relative amounts of the monomers and transfer agent employed during stage a). Of course, the average molecular weights of the (block A)-(block B) diblock copolymer after hydrolysis or of each of the blocks depend on these same relative amounts and also on the degree of hydrolysis, for example depend on the amount of reactant introduced, generally a base, tar this hydrolysis.

For the process for which stages Ia) and Ib) were described in detail above, the theoretical total weights of the block A can be expressed by:

M_{A}n_{A}.

For the process for which stages Ia) and Ib) were described in detail above, the theoretical or targeted average molecular weight of the block A can be expressed by:

M_{A}n_{A}/n_{T}.

For the process for which stages Ia) and Ib) were explained in detail above, the theoretical total weight of the block B′ can be expressed by:

M_{B}n_{B}.

For the process for which stages Ia) and Ib) were explained in detail above, the theoretical or targeted average molecular weight of the block B′ can be expressed by:

M_{B}n_{B}/n_{T}.

For the process for which stages Ia) and Ib) were explained in detail above, the theoretical total weight of the block B can be expressed by:

TM_{AA}n_{B}+(1−T)M_{B}n_{B}.

For the process for which stages Ia) and Ib) were explained in detail above, the theoretical or targeted average molecular weight of the block B can be expressed by:

M_{AA}n_{B}/n_{T}.

(as T=1 according to definition of the theoretical or targeted average molecular weight)

For the process for which stages Ia) and Ib) were explained in detail above, the theoretical total weight of the copolymer can be expressed by:

M_{A}n_{A}+TM_{AA}n_{B}+(1−T)M_{B}n_{B}.

For the process for which stages Ia) and Ib) were explained in detail above, the theoretical average molecular weight of the copolymer can be expressed by:

n_{A}/n_{T}M_{A}+M_{AA}n_{B}/n_{T}.

In the above expressions:
M_{A} is the molar mass of styrene or of the mixture of monomers comprising styrene employed in stage Ia),
M_{AA} is the molar mass of acrylic acid,
M_{B} is the molar mass of the C₁-C₄ alkyl acrylate or of the mixture of monomers comprising the C₁-C₄ alkyl acrylate employed in stage Ib).

The following correspondences are given as reference points:
n_{A}/n_{T}=5 corresponds to a theoretical average molecular weight of the block A of approximately 500 g/mol,
n_{A}/n_{T}=5000 corresponds to a theoretical average molecular weight of the block A of approximately 500 000 g/mol,
n_{B}/n_{T}=5 corresponds to a theoretical average molecular weight of the block B′ of approximately 500 g/mol,
n_{B}/n_{T}=5000 corresponds to a theoretical average molecular weight of the block B′ of approximately 500 000 g/mol,
n_{A}/n_{T}M_{A}+M_{AA}n_{B}/n_{T}=13 000 g/mol (resp. 2000, resp. 8000, resp. 20 000, resp. 50 000) corresponds to a theoretical average molecular weight of the (block A)-(block B) diblock of approximately 13 000 g/mol (resp. 2000, resp. 8000, resp. 20 000, resp. 50 000), taking into consideration a complete hydrolysis, for the case where the alkyl acrylate is ethyl acrylate.

It is noted that the ratios by weight between the blocks are defined as the ratios between the theoretical or targeted total weights (the fiction of a degree of hydrolysis of 1 is not used for this descriptor). Thus:
M_{A}n_{A}≦TM_{AA}n_{B}+(1−T)M_{B}n_{B} indicates that the (block B)/(block A) ratio by weight ≧1. This is a characteristic of the copolymer employed according to the invention.
M_{A}n_{A}/[M_{A}n_{A}+TM_{AA}n_{B}+(1−T)M_{B}n_{B}] indicates the amount by weight of block A in the (block A)-(block B) diblock copolymer, that is to say the proportion of block A.
[TM_{AA}nₙ+(1−T)M_{B}n_{B}]/[M_{A}n_{A}+TM_{AA}n_{B}+(1−T)M_{B}n_{B}]
   indicates the amount by weight of block B in the (block A)-(block B) diblock copolymer, that is to say the proportion of block B.

In particular, it is possible to have:
25 000≦n_{A}/n_{T}M_{A}+M_{AA}n_{B}/n_{T}, or even 28 000≦n_{A}/n_{T}M_{A}+M_{AA}n_{B}/n_{T}, and/or
n_{A}/n_{T}M_{A}+M_{AA}n_{B}/n_{T}≦50 000, or even n_{A}/n_{T}M_{A}+M_{AA}n_{B}/n_{T}≦40 000, and/or
20 000≦n_{A}/n_{T}M_{A}+M_{AA}n_{B}/n_{T}≦50 000, or even 25 000≦n_{A}/n_{T}M_{A}+M_{AA}n_{B}/n_{T}≦50 000, or even 28 000≦n_{A}/n_{T}M_{A}+M_{AA}n_{B}/n_{T}≦40 000.

The theoretical average molecular weight of the copolymer is greater than or equal to 20 000 g/mol. It can in particular be greater than or equal to 25 000 g/mol or even 28 000 g/mol. It can be less than 50 000 g/mol or even than 40 000 g/mol. It is preferably between 20 000 g/mol and 50 000 g/mol and more preferably still between 25 000 g/mol and 50 000 g/mol or even between 28 000 g/mol and 40 000 g/mol.

It is also possible to have
[TM_{AA}n_{B}+(1−T)M_{B}n_{B}]/[M_{A}n_{A}+TM_{AA}n_{B}+(1−T)M_{B}n_{B}]≦75%,
preferably [TM_{AA}n_{B}+(1−T)M_{B}n_{B}]/[M_{A}n_{A}+TM_{AA}n_{B}+(1−T)M_{B}n_{B}]≦85%,
preferably [TM_{AA}n_{B}+1−T)M_{B}n_{B}]/[M_{A}n_{A}+TM_{AA}n_{B}+(1-T)M_{B}n_{B}]≦87%,
preferably [TM_{AA}n_{B}+(1−T)M_{B}n_{B}]/[M_{A}n_{A}+TM_{AA}n_{B}+(1−T)M_{B}n_{B}]≦94%,
preferably 94%≦[TM_{AA}n_{B}+(1−T)M_{B}n_{B}]/[M_{A}n_{A}+TM_{AA}n_{B}+(1−T)M_{B}n_{B}]≦97%.

Advantageously, the measured average molecular weight of the (block A)-(block B) diblock copolymer is greater than or equal to 29 250 g/mol, preferably between 29 250 and 100 000 g/mol, preferably between 29 250 and 90 000 g/mol.

It is noted that, after the preparation of the copolymer, it is possible to put an optional stage IV) of putting into the solid form. This stage can be carried out according to conventional techniques for removing a liquid reaction medium, in particular by evaporation, for example by evaporation of water. For example, a drying stage may be involved. The drying can, for example, be carried out at a temperature of greater than 100° C., preferably of greater than 150° C., for example from 150° C. to 200° C. It can be carried out in the presence of stirring or shearing means which make it possible to obtain powders or granules, such as drums, granulators or coating pans. Use may in particular be made of drying devices suitable for products which may exhibit high viscosities, such as the single-screw or twin-screw devices available from List AG.

### Applications—Uses

In addition to its moisturizing properties, the copolymer can be used in particular in the following compositions:
compositions for household care purposes, in particular for treating the laundry (detergent, softeners), for the dishes (by hand or in a machine), for cleaning or treating hard surfaces (cleaning of floors, kitchens, bathrooms, in the form of products to be diluted and/or to be sprayed, and/or to be applied using wipes),
coating compositions, in particular paint compositions,
compositions used in the construction industry and civil engineering, in particular mastics, seals, asphalts or hydraulic binder compositions, such as cements or plasters,
lubricating compositions, in particular for the Forming or deformation of metals,
compositions used in the context of the exploitation of oil or gas deposits (drilling, fracturing, stimulation or production fluid),
compositions for the treatment or manufacture of paper,
plant protection compositions,
ink or dyeing compositions,
milling compositions.

In these compositions and in other compositions, the copolymer can be used as agent which emulsifies or helps in the emulsification of or agent which disperses or helps in the dispersion of, droplets or particles of use in the composition. If it is used as dispersing agent or dispersing aid, it is preferably used as dispersing agent for compounds other than latexes. The copolymer can be of use in these compositions when they are in the form of emulsions and/or of dispersions. It can also be of use in these compositions when they are intended to emulsify compounds or to disperse compounds. It can also be of use in these compositions for adjusting the viscosity and/or for adjusting the capability of suspending compounds. It can in particular be of use in these compositions for improving the dispersion of solid particles, preventing the presence of visible traces of particles or the presence of agglomerates which modify the feel when they are applied to a surface and/or making it possible to improve their stability. It can in particular be of use in these compositions when they are in the form of emulsions: the disperse phase can be better dispersed and/or more stable. This can in particular reinforce the activity of the disperse phase and/or adjust its sensory properties.

Other details or advantages of the invention may become apparent in the light of the following examples, without a limiting nature.

### EXAMPLE 1

### Copolymer According to the Invention

Preparation of a Polystyrene-Block-Poly(ethyl acrylate-stat-acrylic acid sodium salt) diblock copolymer of type (2b) by synthesis of a polystyrene-block-poly(ethyl acrylate) diblock copolymer of the targeted Mn values 2000-block-42 000 (g/mol), followed by 75% hydrolysis of the ethyl acrylate aster groups

Stage Ia: Preparation of a First Polystyrene Block with a Theoretical Molecular Weight of Approximately 2000 g/mol

3000 g of water, 17.6 g of sodium dodecyl sulfate and 0.290 g of sodium carbonate Na₂CO₃ are introduced into the reactor at ambient temperature. The mixture obtained is stirred under nitrogen for 30 minutes. The temperature is subsequently increased to 75° C. and then a mixture 1 is added comprising:
10.00 g of styrene (St),
0.200 g of methacrylic acid (MAA), and
10.42 g of xanthate (CH₃)(CO₂CH₃)CH—S(C═S)OCH₂CH₃.

The mixture is brought to 85° C. and then a solution of 1.19 g of sodium persulfate Na₂S₂O₈ dissolved in 20.0 g of water is introduced.

After 5 minutes, the addition is begun of a mixture 2 comprising:
90.0 g of styrene (St) and
1.80 g of methacrylic acid (MAA).

The addition is continued for 60 minutes. After complete addition of the various ingredients, the copolymer emulsion obtained is maintained at 85° C. for one hour.

A sample (5 g) is then withdrawn and analyzed by steric exclusion chromatography (SEC) in THF. Its measured number-average molecular weight Mn is equal to 2000 g/mol in polystyrene equivalents (calibration with linear polystyrene standards). Its polydispersity index Mw/Mn is equal to 2.0.

An analysis of the sample by gas chromatography reveals that the conversion of the monomers is greater than 99%.

Stage Ib: Growth of a Second Poly(Ethyl Acrylate) Block with a Theoretical Molecular Weight of Approximately 42 000 g/mol in Order to Obtain a Polystyrene-Block-Poly(Ethyl Acrylate) Diblock Copolymer

The starting material is the emulsified copolymer obtained above in stage Ia after having withdrawn 5 g thereof for analysis and without halting the heating. 1.19 g of sodium persulfate Na₂S₂O₈ diluted in 50.0 g of water are introduced continuously over 3 hours.

Simultaneously, a mixture 3 with the following composition is added at 85° C. over 3 hours:
200.0 g of water,
2.20 g of sodium carbonate Na₂CO₃, and
4.40 g of sodium dodecyl sulfate.

Simultaneously, a mixture 4 with the following composition is added:
2100 g of ethyl acrylate (EA), and
42.0 g of methacrylic acid (MAA).

After complete addition of the various ingredients, the copolymer emulsion obtained is maintained at 85° C. for one hour. 4.40 g of tert-butylbenzyl peroxide are then introduced all at once and the addition is begun of a mixture 5 comprising:
2.20 g of erythorbic acid,
50.0 g of water.

The addition is continued for 60 minutes. After complete addition of the various ingredients, the emulsion is cooled to −25° C. over one hour. A sample (5 g) is then withdrawn and analyzed by steric exclusion chromatography (SEC) in THF. Its measured number-average molecular weight Mn is equal to 41 000 g/mol in polystyrene equivalents (calibration with linear polystyrene standards). Its polydispersity index Mw/Mn is equal to 6.

An analysis of the sample by gas chromatography reveals that the conversion of the monomers is greater than 99.8%. The product obtained is a dispersion of the copolymer in water (latex), with a solids content of approximately 41%.

### Stage II: Partial Hydrolysis (Targeted at 75%) of the Poly(Ethyl Acrylate) Block of the Copolymer Obtained Above in Stage Ib in Order to Obtain the Polystyrene-Block-Poly(Ethyl Acrylate-Stat-Acrylic Acid Sodium Salt) Diblock of the (2b) Type

750 g of water, 250 g of 2-propanol and 1347 g of the emulsified copolymer (ct. 550 g of copolymer on a dry basis) obtained above in stage Ib are introduced into the reactor at ambient temperature. The mixture obtained is stirred for 15 minutes. The temperature is subsequently increased to 75° C. and then 678 g of sodium hydroxide (23.2% by weight solution in water) are added continuously over one hour. After 30 minutes from the beginning of the addition of sodium hydroxide, the continuous addition is begun over one hour of 12 g of aqueous hydrogen peroxide solution (30% solution). After complete addition of the various ingredients, the copolymer solution obtained is maintained at 75° C. for four hours and then cooled to 25° C. over one hour.

The product recovered at the end of the reaction is a translucent gel in water with a solids content of approximately 20%.

The copolymer thus obtained exhibits the following characteristics:
Theoretical average molecular weight of the block A: 2000 g/mol
Theoretical average molecular weight of the block B: 30 000 g/mol
Proportion by weight of the block B: 96%
Proportion by weight of the block A: 4%
Amount by weight of units deriving from ethyl acrylate in the block B: 31%

### EXAMPLE 2

### Comparative Copolymer

Preparation of a Polystyrene-Block-poly(ethyl acrylate-stat-acrylic acid sodium salt) diblock copolymer by synthesis of a polystyrene-block-poly(ethyl acrylate) diblock copolymer of the targeted Mn values 2000-block-20 000 (g/mol), followed by 75% hydrolysis of the ester groups of the ethyl acrylate

Stage Ia: Preparation of a First Polystyrene Block with a Theoretical Molecular Weight of Approximately 2000 g/mol

2150 g of water, 6.00 g of sodium dodecyl sulfate and 0.650 g of sodium carbonate Na₂CO₃ are introduced into the reactor at ambient temperature. The mixture obtained is stirred under nitrogen for 30 minutes. The temperature is subsequently increased to 75° C. and then a mixture 1 is added comprising:
18.2 g of styrene (St),
0.360 g of methacrylic acid (MAA), and
18.9 g of xanthate (CH₃) (CO₂CH₃)CH—S(C═S)OCH₂CH₃.

The mixture is brought to 85° C. and then a solution of 2.16 g of sodium persulfate Na₂S₂O₈ dissolved in 20.0 g of water is introduced.

After 5 minutes, the addition is begun of a mixture 2 comprising:
163.6 g of styrene (St) and
3.30 g of methacrylic acid (MAA).

The addition is continued for 60 minutes. After complete addition of the various ingredients, the copolymer emulsion obtained is maintained at 85° C. for one hour.

A sample (˜5 g) is then withdrawn and analyzed by steric exclusion chromatography (SEC) in THF. Its measured number-average molecular weight Mn is equal to 2000 g/mol in polystyrene equivalents (calibration with linear polystyrene standards). Its polydispersity index Mw/Mn is equal to 2.1.

An analysis of the sample by gas chromatography reveals that the conversion of the monomers is greater than 99%.

Stage IIa: Growth of a Second Poly(Ethyl Acrylate) Block with a Theoretical Molecular Weight of Approximately 20 000 g/mol in Order to Obtain a Polystyrene-Block-Poly(Ethyl Acrylate) Diblock Copolymer

The starting material is the emulsified copolymer obtained above in stage Ia after having withdrawn 5 g thereof for analysis and without halting the heating. 2.16 g of sodium persulfate Na₂S₂O₈ diluted in 50.0 g of water are introduced continuously over 3 hours.

Simultaneously, a mixture 3 with the following composition is added at 85° C. over 3 hours:
200.0 g of water,
4.00 g of sodium carbonate Na₂CO₃, and
8.00 g of sodium dodecyl sulfate.

Simultaneously, a mixture 4 with the following composition is added:
1818 g of ethyl acrylate (EA), and
33.4 g of methacrylic acid (MAA).

After complete addition of the various ingredients, the copolymer emulsion obtained is maintained at 85° C. for one hour.

4.00 g of tert-butylbenzyl peroxide are then introduced all at once and the addition is begun of a mixture 5 comprising:
2.00 g of erythorbic acid,
50.0 g of water.

The addition is continued for 60 minutes. After complete addition of the various ingredients, the emulsion is cooled to ˜25° C. over one hour.

A sample (5 g) is then withdrawn and analyzed by steric exclusion chromatography (SEC) in THF. Its measured number-average molecular weight Mn is equal to 17 500 g/mol in polystyrene equivalents (calibration with linear polystyrene standards). Its polydispersity index Mw/Mn is equal to 2.9.

An analysis of the sample by gas chromatography reveals that the conversion of the monomers is greater than 99.8%.

The product obtained is a dispersion of the copolymer in water (latex), with a solids content of approximately 44%.

Stage II: Partial Hydrolysis (Targeted at 75%) of the Poly(Ethyl Acrylate) Block of the Copolymer Obtained Above in Stage 2 in Order to Obtain the Polystyrene-Block-Poly(Ethyl Acrylate-Stat-Acrylic Acid Sodium Salt) Diblock of the (2a1) Type

900 g of water, 300 g of 2-propanol and 1563 g of the emulsified copolymer (cf. 700 g of copolymer on a dry basis) obtained above in stage Ib are introduced into the reactor at ambient temperature. The mixture obtained is stirred for 15 minutes. The temperature is subsequently increased to 75° C. and then 822 g of sodium hydroxide (23.2% by weight solution in water) are added continuously over one hour.

After 30 minutes from the beginning of the addition of sodium hydroxide, the continuous addition is begun over one hour of 25 g of aqueous hydrogen peroxide solution (30% solution).

After complete addition of the various ingredients, the copolymer solution obtained is maintained at 75° C. for four hours and then cooled to −25° C. over one hour.

The product recovered at the end of the reaction is a translucent gel in water with a solids content of approximately 17%.

The copolymer thus obtained exhibits the following characteristics:
Theoretical average molecular weight of the block A: 2000 g/mol
Theoretical average molecular weight of the block B: 14 000 g/mol
Proportion by weight of the block B: 90%
Proportion by weight of the block A: 10%
Amount by weight of units deriving from ethyl acrylate in the block B: 31%

### EXAMPLE 3

### Evaluations of the Copolymers—Moisturizing Performance

The moisturizing performances of the following solutions are tested by Confocal Laser Raman Microscopy.

### Solution A

| | |
|---|---|
| Distilled water | 93% |
| Glycerol | 7% |

### Solution B

| | |
|---|---|
| Distilled water | 99% |
| Diblock polymer of example 1 | 1% AM |
| according to the invention | |

### Solution D

| | |
|---|---|
| Distilled water | 99% |
| Diblock polymer of comparative example 2 | 1% AM |

### Procedure:

Compacted plantar squamae blocks with a weight of from 80 to 100 mg, with a thickness of more than 100 μm and with a surface area of approximately 1 cm² are used as model of stratum corneum to be moisturized. 5 measurements are carried out on each plantar squama block and 5 blocks are used for each polymer solution, i.e. 25 measurements for each polymer solution.

The amount of polymer solution applied to each block is approximately 50 μl. A confocal laser Raman microscope of LabRam type (Horiba Tobin Yvon) equipped with an He:Ne laser (λ=633 nm with a power of approximately 8.4 mW) and with a CCD detector is used to carry out the measurements. The laser beam is focused in the skin with a ×50 objective and the Raman spectra are recorded using a point-by-point mode from the surface of the sample down into the sample. The acquisition parameters for the spectra are: hole and slit: 200 μm, acquisition time: 30 s over a frequency from 2800 to 4000 cm⁻¹. The microscope in question forms the subject of a technical modification essential for the measurement of the water, with the incorporation of a chamber which makes it possible to control the temperature and the humidity during the acquisitions: the parameters are 25° C. and relative humidity.

The quantification of the water is determined by the ratio of the OH bands of the water to the CH₃ bands of the proteins, in Raman spectrography, as described in:

1 Chrit L, Hadjur C, Morel S, Sockalingum G. D., Lebourdon G, Leroy F and Manfait M: in vivo Chemical Investigation of Human Skin Using a Confocal Raman Optic Microprobe, J. Biomed. Opt., 2005.
2 Caspers F J, Lucassen G W, Carter E A, Bruining H A and Puppels G J: in vivo Confocal Raman Micro-spectroscopy of the Skin: Noninvasive Determination of Molecular Concentration Profiles, Journal of Investigative Dermatology, 2001, 116(3), 434-442.

The water/proteins ratios in the stratum corneum were determined in Raman spectrography by calculating the ratio of the intensity of the OH bands of the water (area under the curve), integrated between 3350 cm⁻¹ and 3550 cm⁻¹, to the intensity of the CH₃ bands of the proteins (area under the curve), integrated between 2910 cm⁻¹ and 2965 cm⁻¹.

The quantification of the water is calculated from the following equations:

W/P=(m_{w}/mₚ)R

Water content (%): m_{w}/(m_{w}+mₚ)=100% (W/E)/(W/(P+R)) m_{w} and mₚ respectively being the weights of water and of proteins in the volume of the sample tested;
W being the intensity of the integrated Raman signal of the water (integrated OH bands of the water (area under the curve));
P being the intensity of the integrated Raman signal of the proteins (integrated CH₃ bands of the proteins (area under the curve));
R being a proportionality constant expressing the ratio of the Raman signals of the water to the Raman signals of the proteins in a 50% solution.

The water content is expressed in grams of water per 100 g of moist tissues.

These functionalities are integrated in the LabSpec software from Horiba Jobin Yvon.

In order to evaluate the moisturizing performance, the measurements are carried out at T-0, before the treatment, and at T+1 hour after the treatment, from the surface to a depth of 20 μm.

### Results

| | Moisturizing performance by |
|---|---|
| Solution | confocal laser Raman microscopy |
| A | 1 |
| B | 117 |
| D | 1.92 |

Significantly, the diblock copolymer according to the invention, as a 1% solution in water, has a moisturizing performance, measured by confocal laser Raman microscopy, which is much better than that of 7% glycerol in water and than that of the comparative copolymer.

1-22. (canceled)

23. A (block A)-(block B) diblock copolymer wherein:
block A comprises at least 90% by weight of styrene units deriving from styrene, and
block B is a random block comprising:
(a) from 34% to 95% by weight of units deriving from acrylic acid in the acid or salified form, and
(b) from 5% to 66% by weight of units deriving from a C₁-C₄ alkyl acrylate,
wherein:
the proportion by weight of block B with respect to the diblock copolymer is greater than or equal to 50%, and
the theoretical average molecular weight of the diblock copolymer is greater than or equal to 20,000 g/mol.

24. The copolymer of claim 23, wherein said diblock copolymer is linear and block B is a random block.

25. The copolymer of claim 23, wherein the C₁-C₄ alkyl acrylate is ethyl acrylate.

26. The copolymer of claim 23, wherein block A and/or block B comprises up to 10% by weight of an additional ionic or nonionic hydrophilic co-monomer.

27. The copolymer of claim 26, wherein the hydrophilic co-monomer is methacrylic acid in the acid or salified form.

28. The copolymer of claim 23, wherein the proportion by weight of the block B, with respect to the copolymer, is greater than or equal to 75%.

29. The copolymer of claim 23, wherein said diblock copolymer is:
in a solid or dry form, or
in the form of a fluid concentrated ingredient comprising a carrier, in a concentration of greater than 10% by weight.

30. The copolymer claim 23, wherein:
said diblock copolymer is in the form of a fluid concentrated ingredient comprising a carrier, in a concentration of greater than 10% by weight, and
the carrier comprises water and/or an alcohol solvent.

31. The copolymer of claim 30, wherein:
the carrier is water or a mixture of more than 50% by weight of water and of less than 50% by weight of alcohol, and
said concentration is at least 25% by weight.

32. A process for the preparation of the copolymer of claim 23, comprising: stage I): preparing:
a (block A)-(block B′) diblock copolymer, or
a triblock or star copolymer comprising a (core)-[(block A)-(block B′)]ₓ or (core)-[(block B′)-(block A)]ₓ architecture, where x is a mean number of greater than or equal to 2,
wherein:
block A comprises the units deriving from styrene, and
block B′ comprises the units deriving from a C₁-C₄ alkyl acrylate, stage I′): optionally, for a triblock or star copolymer, splitting the (core)-(block B′) or (core)-(block A) bonds to obtain a (block A)-(block B′) diblock copolymer, and stage II): hydrolyzing the block B′ to the block B to yield the (block A)-(block B) diblock copolymer,
wherein for a triblock or star copolymer, said hydrolysis, if appropriate, splits the (core)-(block B′) or (core)-(block A) bonds to yield the (block A)-(block B) diblock copolymer.

33. The process of claim 32, wherein stage I) is carried out by emulsion polymerization in water.

34. The process of claim 32, wherein:
during stage I, the (block A)-(block B′) diblock copolymer is prepared by a process comprising the following intermediate stages Ia) and Ib):
Ia) preparing a first block A by bringing together:
n_{T} moles of a transfer agent comprising a single transfer group,
n_{A} moles of styrene or a mixture of monomers comprising at least 90% by weight of styrene, where n_{A}/n_{T}>5; and
optionally a free radical initiator,
Ib) preparing a second block B' to obtain a (block A)-(block B′) diblock copolymer by bringing together:
the block A obtained in stage Ia,
n_{B} mol of a hydrolyzable C₁-C₄ alkyl acrylate or of a mixture of monomers
comprising at least 90% by weight of the hydrolyzable C₁-C₄ alkyl acrylate, where n_{B}/n_{T}>5; and
optionally a free radical initiator; and
during stage II), subsequent to stage I), hydrolyzing the block B′ to a degree T ranging from 0.4 to 0.96 moles to obtain said (block A)-(block B) diblock copolymer,
wherein:
20,000≦n_{A}/n_{T}M_{A}+M_{AA}n_{B}/n_{T}, and
[TM_{AA}n_{B}+(1−T)M_{B}n_{B}]/[M_{A}n_{A}+TM_{AA}n_{B}+(1−T)M_{B}n_{B}]≧50%,
where:
M_{A} is the molar mass of the styrene or of the mixture of monomers comprising the styrene employed in stage Ia), and
M_{B}, is the molar mass of the C₁-C₄ alkyl acrylate or of the mixture of monomers comprising the C₁-C₄ alkyl acrylate employed in stage Ib).

35. The process of claim 34, wherein T ranges from 0.7 to 0.8 moles.

36. The process of claim 34, wherein:
20,000≦n_{A}/n_{T}M_{A}+M_{AA}n_{B}/n_{T}≧50,000.

37. The process of claim 34, wherein:
[TM_{AA}n_{B}+(1−T)M_{B}n_{B}]/[M_{A}n_{A}+TM_{AA}n_{B}+(1−T)M_{B}n_{B}]≧75%.

38. The process of claim 32, wherein the average molecular weight of the (block A)-(block B′) diblock copolymer is greater than or equal to 29,250 g/mol.

39. The process of claim 32, further comprising a stage III) that is carried out during and/or after stage II) comprising:
deactivating transfer groups carried by macromolecular chains; and/or
purifying the (block A)-(block B) diblock copolymer; and/or
destroying hydrolysis and/or deactivation byproducts.

40. The process of claim 32, wherein stage I) is carried out by controlled radical polymerization with a transfer agent comprising a transfer group of formula —S—CS—.

41. The process of claim 34, wherein in stage Ia), said mixture of monomers comprising at least 90% by weight of styrene additionally comprises up to 10% by weight of an anionic or nonionic hydrophilic co-monomer.

42. The process of claim 34, wherein, in stage Ib), said mixture of monomers comprising at least 90% by weight of the hydrolyzable C₁-C₄ alkyl acrylate additionally comprises up to 10% by weight of an ionic or nonionic hydrophilic co-monomer.

43. The process of claim 41, wherein the hydrophilic co-monomer is methacrylic acid in the acid or salified form.

44. The process of claim 32, wherein the C₁-C₄ alkyl acrylate is ethyl acrylate.
